(19) United States
(12) Patent Application Publication
(10) Pub. No.: US 2014/0027667 A1
(43) Pub. Date: Jan. 30, 2014

(54) IRON COBALT TERNARY ALLOY NANOPARTICLES WITH SILICA SHELLS

(71) Applicant: Michael Paul Rowe, Pinckney, MI (US)

(72) Inventor: Michael Paul Rowe, Pinckney, MI (US)

(73) Assignee: Toyota Motor Engineering & Manufacturing NA, Erlanger, KY (US)

(21) Appl. No.: 13/558,397

(22) Filed: Jul. 26, 2012

(51) Int. Cl. H01F 1/01; B22F 9/20; B82Y 30/00; B82Y 40/00

(52) U.S. Cl. 252/62.55; 75/351; 977/773; 977/896

(57) ABSTRACT

Superparamagnetic core shell nanoparticles having a core of a iron cobalt ternary alloy and a shell of a silicon oxide directly on the core and a particle size of 2 to 200 nm are provided. Methods to prepare the nanoparticles are also provided.

### BACKGROUND OF THE INVENTION

1. Field of the Invention

This invention is directed to novel coated superparamagnetic alloy nanoparticles and methods to prepare such materials. In particular, the invention is directed to iron cobalt ternary alloy nanoparticles containing a third transition metal component, such as for example vanadium or chromium.

2. Discussion of the Background

Iron cobalt alloys are conventionally utilized in the construction of magnetic cores of motors, generators and transformers. Conventionally, such cores have been constructed of laminate structures of magnetic alloys, typically iron-cobalt-vanadium or iron-cobalt chromium alloys. Such laminate structures generally consist of alloy metal layers sandwiched with interlaminar insulation and binder layers. These interlaminar layers are necessary to insure high electrical efficiency of the magnetic core.

However, ever increasing demand for greater and more efficient performance of motors, generators and transformers has spurred a search for new materials with which compact magnetic cores having greatest saturation induction and little or no hysteresis loss can be constructed.

The most important characteristics of such soft magnetic core components are their maximum induction, magnetic permeability, and core loss characteristics. When a magnetic material is exposed to a rapidly varying magnetic field, a resultant energy loss in the core material occurs. These core losses are commonly divided into two principle contributing phenomena: hysteresis and eddy current losses. Hysteresis loss results from the expenditure of energy to overcome the retained magnetic forces within the core component. Eddy current losses are brought about by the production of induced currents in the core component due to the changing flux caused by alternating current (AC) conditions.

The use of powdered magnetic materials allows the manufacture of magnetic parts having a wide variety of shapes and sizes. Conventionally, however, these materials made from consolidated powdered magnetic materials have been limited to being used in applications involving direct currents. Direct current applications, unlike alternating current applications, do not require that the magnetic particles be insulated from one another in order to reduce eddy currents.

Conventionally, magnetic particles are coated with thermoplastic materials to act as a barrier between the particles to reduce induced eddy current losses. However, in addition to the relatively high cost of such coatings, the plastic has poor mechanical strength and as a result, parts made using plastic-coated particles have relatively low mechanical strength. Additionally, many of these plastic-coated powders require a high level of binder when pressed. This results in decreased density of the pressed core part and, consequently, a decrease in magnetic permeability and lower induction. Additionally, and significantly, such plastic coatings typically degrade at temperatures of 150-200° C. Accordingly, thermoplastic coated magnetic particles are of limited utility.

Thus, there is a need for new magnetic powders to produce soft magnetic parts, which provide increased green strength, high temperature tolerance, and good mechanical properties and which parts have minimal or essentially no core loss.

Conventionally, ferromagnetic powders have been employed for the production of soft magnetic core devices. Such powders are generally in a size range measured in microns and are obtained by a mechanical milling diminution of a bulk material. Superparamagnetic nanoparticle materials having particle size of less than 100nm have found utility for magnetic record imaging, as probes for medical imaging and have been applied for targeted delivery of therapeutic agents. However, these utilities have generally been limited to superparamagnetic iron oxide nanoparticles and little effort has been directed to the development of iron-cobalt ternary alloy nanoparticles suitable for utilization in the production of core magnetic parts.

Brunner (U.S. Pat. No. 7,532,099) describes coated alloy particles which are employed with a ferromagnetic alloy powder and a thermoplastic or duroplastic polymer to prepare an injection molded or cast soft magnetic core. An alloy of Iron, copper, niobium, silicon and boron is heat treated to form a nanocrystalline structure, then comminuted in a mill to obtain particles having dimensions of about 0.01 to 1.0 mm.

An abrasion resistant layer of iron and silicon oxide of 150 to 400nm is coated to the particles.

Anand et al. (U.S. Pat. No. 6,808,807) encapsulated ferromagnetic powders obtained by coating a ferromagnetic core with a polyorganosiloxane or polyorganosilane and thermally treating the coated core to convert the polymer to a residue containing silicon and oxygen. The core alloy may be any of iron alloyed with silicon, aluminum, nickel, cobalt, boron, phosphorous, zirconium, neodymium and carbon. Ferromagnetic core particles having an average diameter of less than 2 mm are suitable for this composition.

Deevi et al. (U.S. Pat. No. 6,746,508) describes nanoparticles of FeCoV made by a method known as pulsed laser vaporization with controlled condensation (LVCC). The powder can be compressed in the presence of a binder and the binder burned out. The compacted form is further mechanically processed to a final form. Utility in magnetic applications such as transformers and choke coils is described.

Lashmore et al. (U.S. Pat. No. 6,251,514) describes a ferromagnetic powder containing particles of about 40 to 600 microns. Examples of the ferromagnetic material include carbon steel, tungsten steel, Vicalloy (Fe/Co/V alloy) and iron powder. The particles are coated with a combination of an iron oxide and another iron oxate salt such as iron chromate.

Gay et al. (U.S. Pat. No. 6,193,903) describes ceramic coated ferromagnetic powders. The powders are iron or an iron alloy and the encapsulating layer on the particle may be one of a group of ceramics such as a metal oxide, metal nitride, metal silicate and a metal phosphate. The particle size is from 5 to 1000 microns. Silica is listed as one of a large group of ceramic materials suitable as the coating.

Moorhead et al. (U.S. Pat. No. 6,051,324) describes particles of an alloy of iron/cobalt/vanadium having a particle size of less than 44 microns which are coated with a glass, a ceramic or a ceramic glass, including silicon dioxide.

Atarashi et al. (U.S. Pat. No. 5,763.085) describes a magnetic particle having multiple layers on its surface which is useful as a starting material for color magnetic materials such as magnetic toners. The particles are of a size of from 0.01 to 200 μm. Silicon dioxide is described as a metal oxide coating along with preparation by a sol gel method. Description of preparation of a metal layer on the particle by reduction of a soluble metal salt in the presence of a complexing agent is provided.

Bennett et al. (U.S. Pat. No. 5,381,664) describes a magnetic refrigeration system containing a nanocomposite supermagnetic material containing nanosize particles of a magnetic component. Particles are from 1 to 1000nm in size. Materials believed suitable as a magnetic constituent are listed. However, an alloy of Fe/Co/V is not included. Silica and silicon dioxide are included as materials suitable for a bulk matrix component.

Yamanaka et al. (U.S. Pat. No. 4,983,231) describes a surface treated magnetic powder obtained by treating an iron-rare earth metal alloy with alkali-modified silica particles. The mean particle diameter of the alloy particles is from 20 to 200 μm. Upon heating the alkali silicate dehydrates and condenses to form a “polysiloxane” coating.

Trimble et al. (U.S. Pat. No. 3,882,507) describes magnetochemical particles which can interact with the chemical environment and provide a visible change. Metal alloy spheres having a diameter of from 5 to 100 microns are coated with metal layers which can be chemically removed and the removal results in color formation.

Uozumi et al. (JP 2007-123703) describes application of a silicate coating to soft magnetic powders including alloys of iron, cobalt and vanadium, having a mean particle size of 70 microns. The coated particles are heat treated cause migration of Si and 0 into the soft magnetic core to form a diffusion zone between the outer oxide layer and the soft magnetic core.

Yamada et al. (JP 03-153838)(Abstract) describes surface treatment of an iron/cobalt/vanadium powder with a compound containing silicon and an alkoxy group (such as vinyl triethoxysilane). No description of particle size or method to produce the alloy particle is provided.

Sun et al (J. Am. Chem. Soc., 2002, 124, 8204-8205) describes a method to produce monodisperse magnetite nanoparticles which can be employed as seeds to grow larger nanoparticles of up to 20 nm in size.

Bumb et al. (Nanotechnology, 19, 2008, 335601) describes synthesis of superparamagnetic iron oxide nanoparticles of 10-40 nm encapsulated in a silica coating layer of approximately 2 nm. Utility in power transformers is referenced, but no description of preparation of core structures is provided.

Zhang et al. (Nanotechnology, 19, 2008, 085601) describes synthesis of silica coated iron oxide particles. The average size of the iron oxide particle to be coated is 8 to 10 nm and the silica core is about 2 nm.

Liu (U.S. 2010/0054981) describes a system of magnetic nanoparticles which is a composite of a hard magnetic material and a soft magnetic material. For example, a “bimagnetic” FePt/Fe₃O₄ nanoparticle is described.

Hattori et al. (U.S. 2006/0283290) describe silica coated, nitrided iron particles having an average particle diameter of 5 to 25 nm. The particles are “substantially spherical” and are useful for magnetic layers such as a magnetic recording medium.

Tokuoka et al. (U.S. Pat. No. 7,678,174) describe an iron based powder particle having an iron or iron alloy core and an oxide type insulating coating, including silicon oxide. An ester wax is also added to the particle surface. The coated powder particles are on the order of 200 microns in size as described in Example 1. The lubricated powder is pressure molded to form a molded body and the molded body heat treated.

Yu et al. (J. Phys. Chem. C 2009. 113, 537-543) describes the preparation of magnetic iron oxide nanoparticles encapsulated in a silica shell. Utility of the particles as magnetic binding agents for proteins is studied.

None of the above references disclose or suggest superparamagnetic nanoparticles containing an iron-cobalt ternary alloy core and a shell coating of a silicon oxide directly on the alloy core.

### SUMMARY OF THE INVENTION

Applicant is directing effort and resources to the study of materials which would be useful to produce a magnetic core having the properties required for production of future high performance motors, generators and transformers. In the course of that effort, it has been surprisingly discovered that silica coated superparamagnetic iron-cobalt ternary alloy nanoparticles are materials of high interest.

Therefore, an object of the present invention is to provide a superparamagnetic powder to produce soft magnetic parts, having increased green strength, high temperature tolerance, and good mechanical properties for the production of high performance magnetic cores.

A second object of the invention is to provide a method to prepare the powder nanoparticles of such superparamagnetic powder.

These and other objects have lbeen achieved according to the present invention, the first embodiment of which provides a core shell nanoparticle, comprising: a core of an iron cobalt ternary alloy; and a shell of a silicon oxide directly coating the core; wherein a particle size of the nanoparticle is from 5 to 200 nm.

In a preferred embodiment according to the invention, the third component of the iron cobalt ternary alloy is selected from the group consisting of scandium, titanium, vanadium, chromium, manganese, nickel, copper and zinc.

In a highly preferred embodiment, according to the present invention the third component is vanadium or chromium.

In a further preferred embodiment, the silicon oxide shell comprises silicon dioxide.

In a further embodiment, the present invention provides a method to prepare core shell nanoparticles, the core comprising iron, cobalt and a transition metal other than iron and cobalt, the shell comprising a silicon oxide, the method comprising:

dissolving each of an iron salt, a cobalt salt and a transition metal salt in an alkaline alcoholic solution to obtain a solution of the iron salt, the cobalt salt, and the transition metal salt other than iron and cobalt;

treating the solution with a reducing agent to produce nanoparticles of an iron cobalt ternary alloy;

coating the alloy particles with a silicon oxide shell to obtain the core shell nanoparticles.

The foregoing paragraphs have been provided by way of general introduction, and are not intended to limit the scope of the following claims. The presently preferred embodiments, together with further advantages, will be best understood by reference to the following detailed description taken in conjunction with the accompanying drawings.

### BRIEF DESCRIPTION OF THE DRAWINGS

FIG. 1 shows a TEM image of nanoparticles prepared in Example 1.

FIG. 2 shows a XRD spectrum of nanoparticles prepared in Example 1.

FIG. 3 shows a generalized relationship of particle size and range of superparamagnetism.

FIG. 4 shows a TEM image of nanoparticles prepared in Example 2.

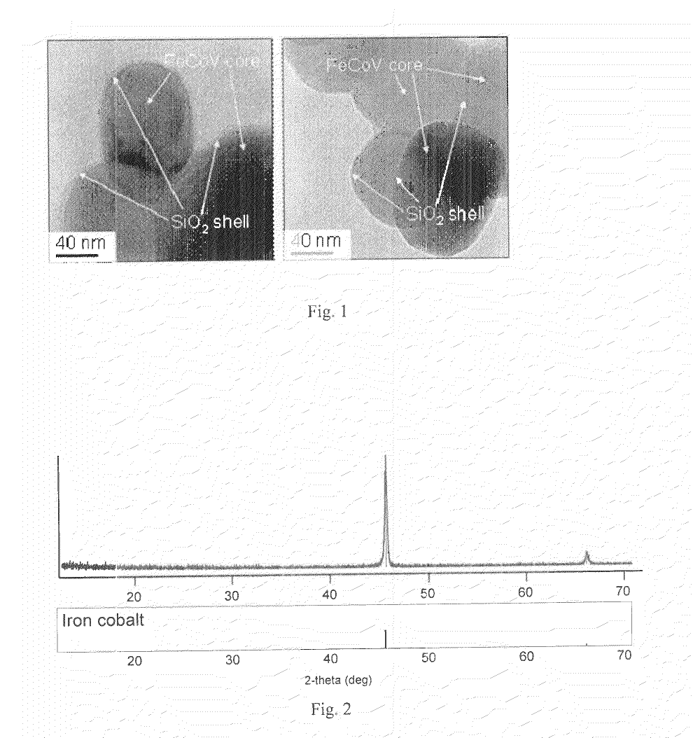

### DETAILED DESCRIPTION OF THE INVENTION

The inventor has recognized that to increase magnetic core efficiency as measured in terms of core loss, the magnetic core must demonstrate a reduced measure of magnetic hysteresis as well as lowered eddy current formation. In a related application, the inventor has described the utility of superparamagnetic iron oxide nanoparticles encapsulated in silica shells for preparation of a monolithic nanomaterial core having zero (or very low) hysteresis and very low eddy current formation.

While not being constrained to theory, control of grain size to approximately that of the particle magnetic domain is believed to be a factor contributing to reduced hysteresis of the magnetic core. Moreover, the presence of insulating silica shells about the core grains is a factor which contributes to the low eddy current formation of a magnetic core according to the present invention.

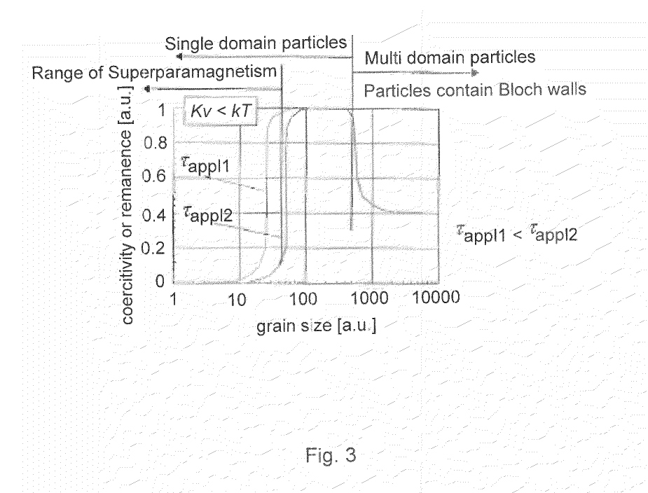

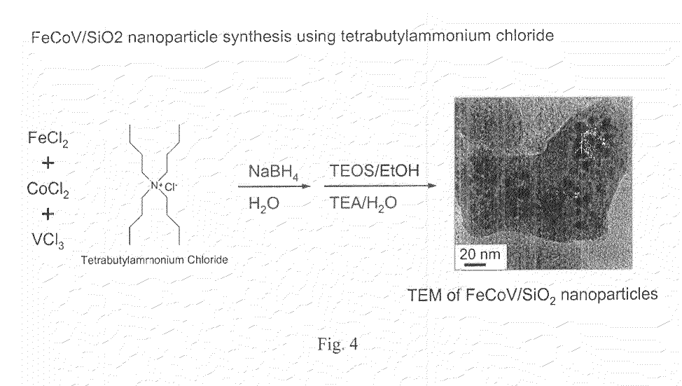

This discovery has led the inventor to seek other nanoparticles having a core of a superparamagnetic nanoparticles. In order to obtain such a material the nanoparticles core must be produced to be near or below its magnetic domain size. Otherwise, the sample will become ferromagnetic, and express magnetic hysteresis. This phenomenon is shown in FIG. 4 which is reproduced from Nanomaterials An Introduction to Synthesis, Properties and Applications by Dieter Vollath (page 112) Wiley-VCH. According to FIG. 3, above a certain size range, nanoparticles will exhibit a measurement time dependency characteristic of ferromagnetic behavior. To avoid this time dependency nanoparticles of a size within the range of superparamagnetism must be prepared and maintained.

Thus, the first embodiment of the invention is a core shell nanoparticle, comprising:

a core of an iron cobalt ternary alloy; and

a shell of a silicon oxide directly coating the core; wherein

the third component of the ternary alloy is a transition metal selected from the group consisting of scandium, titanium, vanadium, chromium, manganese, nickel, copper and zinc, and a particle size of the nanoparticle is from 2 to 200 nm, preferably 2 to 160 nm and most preferably, 5 to 30 nm.

The alloy composition is not limited and any composition conventionally known may be employed according to the present invention. Generally, the ternary component may constitute from 0.1 to 5% by weight of the alloy nanoparticles.

In preferred embodiments, the ternary alloy consists of iron cobalt and vanadium and the vanadium content is 2% by weight or less.

In another preferred embodiment, the ternary alloy is an iron cobalt chromium alloy and the chromium content is 1% by weight or less.

The silicon oxide shell is directly coated onto the alloy nanoparticles and may of any appropriate width. However, to be of utility as a powder to prepare high performance magnetic cores, the shell width may be from 0.5 to 10 nm. This range includes all values and subranges therebetween. In a highly preferred embodiment the silicon oxide of the shell is silicon dioxide.

Surprisingly the inventor has discovered that the ternary alloy core shell nanoparticles according to the invention may be prepared by a process comprising:

dissolving each of an iron salt, a cobalt salt and a transition metal salt other than iron and cobalt in an alkaline alcoholic solution of a ligand to obtain a solution of the metal salts;

treating the solution with a reducing agent to produce nanoparticles of an iron cobalt ternary alloy; and

coating the alloy particles with a silicon oxide shell to obtain the core shell nanoparticles.

In a preferred embodiment, the reducing agent is a metal hydride, most preferably sodium borohydride.

Following preparation, the alloy nanoparticles may optionally be isolated and removed from the synthesis mother liquors and further washed to remove contaminant materials.

In any case, the alloy nanoparticles may be coated directly with a semi-conductive or non-conductive material; preferably a silicon oxide shell by dispersing the alloy nanoparticles in an aqueous solution of a trialkylamine; adding a tetraalkyl orthosilicate to the dispersion; and reacting the orthosilicate to form a silicon oxide coating on the nanoparticles.

The iron, cobalt and transition metal salts employed are not limited as long as they are soluble in the alkaline alcoholic solvent. The transition metal other than iron and cobalt is selected from the group consisting of scandium, titanium, vanadium, chromium, manganese, nickel, copper and zinc. The salts may preferably be halides, more preferably chlorides.

In highly preferred embodiments the transition metal other than iron and cobalt is vanadium or chromium and a halide salt of either vanadium or chromium is employed as the source of the metal.

The alkaline alcoholic solution comprises at least one alcohol selected from the group consisting of methanol, ethanol, n-propanol, 2-propanol, n-butanol and 2-butanol. In a preferred embodiment, the alcohol is ethanol.

Any ligand which is effective to coordinate to the metal nanoparticle surface may be employed. In a preferred embodiment, sodium citrate is the chelating agent, preferably tribasic sodium citrate. In another embodiment a tetraalkylammonium halide ligand is employed and preferably the tetraalkylammonium halide ligand is tetrabutylammonium chloride.

Any reducing agent capable of reducing the metal ions to the metal state may be utilized. In a preferred embodiment the reducing agent is sodium borohydride.

Having generally described this invention, a further understanding can be obtained by reference to certain specific examples which are provided herein for purposes of illustration only and are not intended to be limiting unless otherwise specified.

### EXAMPLE 1

To a reaction flask was added 1050 mL ethanol, 2.056 g NaOH, and 145.102 g tribasic sodium citrate. After the sodium hydroxide had an opportunity to dissolve, 20.967 g iron dichloride tetrahydrate, 23.786 g cobalt dichloride hexahydrate, and 0.695 g vanadium trichloride were dissolved in the reaction mixture.

24.301 g sodium borohydride were dissolved in 900 mL of ethanol.

The sodium borohydride solution was then added to the reaction. The reaction was allowed to stir for 10 additional minutes after all of the sodium borohydride was added.

The product was then purified using a washing solution of 70% H₂O/30% ethanol (by volume).

The nanoparticles were stirred for 20 minutes to fully disperse them throughout a water/triethylamine solution (1260 mL H₂O and 33 mL triethylamine). 3.3 mL tetraethyl orthosilicate was then dissolved in 780 mL ethanol, and added to the stirring reaction flask. After 20 additional minutes of stirring, the product was again collected using a permanent magnet. This final core/shell product was washed with ethanol.

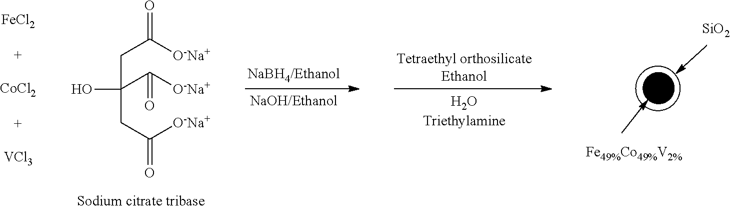

### EXAMPLE 2

To a reaction flask was added 1050 mL ethanol, 1.0 g NaOH, and 11.96 g tetrabutylammonium chloride. After the sodium hydroxide had an opportunity to dissolve, 20.967 g iron dichloride tetrahydrate, 23.786 g cobalt dichloride hexahydrate, and 0.695 g vanadium trichloride were dissolved in the reaction mixture.

24.301 g sodium borohydride were dissolved in 900 mL of ethanol.

The sodium borohydride solution was then added to the reaction. The reaction was allowed to stir for 10 additional minutes after all of the sodium borohydride was added.

The product was then purified using a washing solution of 70% H₂O/30% ethanol (by volume).

The nanoparticles were stirred for 20 minutes to fully disperse them throughout a water/triethylamine solution (1260 mL H₂O and 33 mL triethylamine). 3.3 mL tetraethyl orthosilicate was then dissolved in 780 mL ethanol, and added to the stirring reaction flask. After 20 additional minutes of stirring, the product was again collected using a permanent magnet. This final core/shell product was washed with ethanol.

1. A core shell nanoparticle, comprising:
a core of an iron cobalt ternary alloy; and
a shell of a silicon oxide directly coating the core;
wherein
the third component of the ternary alloy is a transition metal selected from the group consisting of scandium, titanium, vanadium, chromium, manganese, nickel, copper and zinc, and
a particle size of the nanoparticle is from 2 to 200 nm.

2. The core shell nanoparticles according to claim 1, wherein the iron cobalt ternary alloy is an iron cobalt vanadium alloy.

3. The core shell nanoparticles according to claim 1, wherein the iron cobalt ternary alloy is an iron cobalt chromium alloy.

4. The core shell nanoparticles according to claim 1, wherein the silicon oxide of the shell is silicon dioxide.

5. The core shell nanoparticles according to claim 1, wherein the particle size of the nanoparticle is from 2 to 160 nm.

6. A method to prepare core shell nanoparticles, the core comprising iron, cobalt and a transition metal other than iron and cobalt, the shell comprising a silicon oxide, the method comprising:
dissolving each of an iron salt, a cobalt salt and a transition metal salt in an alkaline alcoholic solution with a ligand to obtain a solution of the iron salt, the cobalt salt, and the transition metal salt other than iron and cobalt;
treating the solution with a reducing agent to produce nanoparticles of an iron cobalt ternary alloy;
coating the alloy particles with a silicon oxide shell to obtain the core shell nanoparticles.

7. The method of claim 6, wherein the reducing agent is a metal hydride.

8. The method of claim 7, wherein the metal hydride is sodium borohydride.

9. The method of claim 6, wherein coating the alloy particle comprises:
dispersing the alloy nanoparticles in an aqueous solution of a trialkylamine;
adding a tetraalkyl orthosilicate to the dispersion; and
reacting the orthosilicate to form a silicon oxide coating on the nanoparticles.

10. The method of claim 6, wherein the transition metal other than iron and cobalt is selected from the group consisting of scandium, titanium, vanadium, chromium, manganese, nickel, copper and zinc.

11. The method according to claim 10, wherein the transition metal is vanadium or chromium.

12. The method according to claim 6, wherein the alkaline alcoholic solution comprises at least one selected from the group consisting of methanol, ethanol, n-propanol, 2-propanol, n-butanol and 2-butanol.

13. The method according to claim 6, wherein the ligand is tribasic sodium citrate.

14. The method according to claim 6, wherein the ligand is a tetraalkylammonium halide.

15. The method according to claim 6, wherein the ligand is tetrabutylammonium chloride.
